(19) United States
(12) Patent Application Publication
(10) Pub. No.: US 2009/0224047 A1
(43) Pub. Date: Sep. 10, 2009

(54) Contactless Scan Position Orientation Sensing

(75) Inventor: Peter Johnston, San Mateo, CA (US)

Correspondence Address: FINNEGAN, HENDERSON, FARABOW, GARRETT & DUNNER;LLP, 901 NEW YORK AVENUE, NW, WASHINGTON, DC, 20001-4413, US

(73) Assignee: Konica Minolta Systems Laboratory, Inc.

(21) Appl. No.: 12/042,922

(22) Filed: Mar. 5, 2008

(51) Int. Cl. G06K 7/08

(52) U.S. Cl. 235/449

(57) ABSTRACT

Systems, methods, apparatus, and user-interfaces consistent with embodiments of the present invention provide for contactless document scanning using portable scanners. A magnetic field sensor may use variations in a known magnetic field and may provide information related to the orientation of a portable scanner relative to an image on a medium being scanned. The orientation information provided by magnetic field sensor may be used to determine the orientation of a scanner when the sensory threshold of motion sensors on the portable scanner has been exceeded.

### BACKGROUND

1. Field of the Invention

The present invention relates to the field of document scanning and in particular, to contactless scan position orientation sensing.

2. Description of Related Art

Computer scanners such as document scanners, printers, and multi-function devices facilitate the conversion of physical documents into electronic form and vice-versa. For example, a physical document may be scanned and stored in electronic form on a computer. A scanned image is an electronic representation of an image on a medium. The scanned image may sometimes be represented as a sequence of pixels. A user may occasionally configure a scanner prior to scanning by selecting from various scan or document related options such as scan resolution, document size, format of the output file, etc. Typically, the scanned image may be transmitted to a computer over a network and may be saved at a default or user-specified location.

Scanners coupled to computing devices may be of various types including flatbed scanners and handheld scanners. Scanners may also be incorporated into multi-function devices, which may additionally include one or more of printing, facsimile, and/or copying functions. Flatbed scanners are relatively fast and well-suited for standard scanning jobs from standard size paper sheets, while portable scanners, including handheld scanners, offer flexibility and the ability to scan images from a variety of media types and sizes.

In some portable scanners, image and/or motion sensors in the scanner allow the device to orient itself to an image. In a portable scanner, it is possible to measure the rotation of the scanner on the media via the motion sensors that may be embedded on the bottom of the scanner. These sensors, which may be mechanical (such as moving wheel) sensors or optical sensors (such as those used in optical mice), can measure direction and speed and thus calculate device rotation. However, motion sensors often require actual physical contact or extreme proximity to the media/image. When the scanner is lifted beyond a certain distance from the media, these sensors may no longer be able to accurately measure motion or rotation. Thus, when the distance between the scanner and the media or image exceeds the scanner's sensory threshold then the image may no longer be accessible to the scanner. For example, if the user momentarily lifts the scanner off the page, sensor orientation information may be lost and job flow may be interrupted. Consequently, a user may perform a reorientation of the scanner and follow the reorientation process by rescanning affected portions of the image. Thus, there is a need for apparatus, systems, methods, and user-interfaces to facilitate the scanning of documents using portable scanners to allow users to effect greater control and to afford the user greater convenience during the scanning process.

### SUMMARY

In accordance with the present invention, systems, methods, user-interfaces, and apparatus for contactless position orientation sensor for scanning devices are presented. In some embodiments, a portable scanner may comprise at least one processor capable of processing image data, at least one image sensor coupled to the processor, wherein the image sensor is capable of scanning images on a medium and communicating scanned image data to the processor; memory coupled to the processor capable of storing image data; at least one motion sensor coupled to the processor, wherein the motion sensor provides positional correlation information for the scanned image data; and at least one magnetic field sensor coupled to the processor, wherein the magnetic field sensor provides information pertaining to the orientation of the portable scanner to the processor. Embodiments of the invention also pertain to methods and systems for maintaining positional correlation information obtained from motion sensors in a portable scanner relative to image data on a medium.

These and other embodiments are further explained below with respect to the following figures.

### BRIEF DESCRIPTION OF THE DRAWINGS

FIG. 1 shows a block diagram of an exemplary system for document scanning using portable scanners.

FIG. 2 depicts a block diagram of an exemplary portable scanner.

FIG. 3 depicts an exemplary flowchart for scanning an image using an exemplary portable scanner.

### DETAILED DESCRIPTION

In accordance with the present invention, systems and methods for secure document scanning are presented.

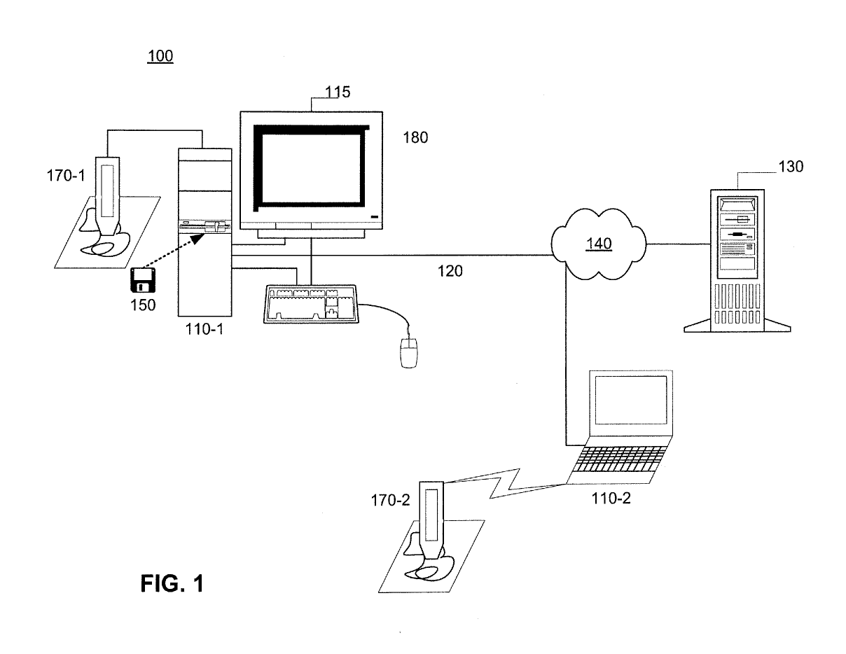

FIG. 1 shows a block diagram of an exemplary system for the document scanning using portable scanner. A portable scanner and any associated computer software application(s) consistent with the present invention may be deployed on a network of computers and other peripherals as shown in FIG. 1, that are connected through communication links that allow information to be exchanged using conventional communication protocols and/or data port interfaces.

As shown in FIG. 1, exemplary system 100 includes computing devices 110-1, 110-2, and server 130. Further, computing devices 110 and server 130 may communicate over a connection 120, which may pass through network 140, which in one case could be the Internet. Computing devices 110 may be a computer workstation, desktop computer, laptop computer, or any other computing device capable of being used in a networked environment. Server 130 may be a platform capable of connecting to computing device 110, portable scanners 170, and other devices too (not shown). Computing device 110 and server 120 may be capable of executing software (not shown) that allows the control and configuration of portable scanners 170, such as exemplary portable scanners 170-1 and 170-2. Exemplary portable scanners 170-1 and 170-2 include handheld scanners that are capable of scanning and/or digitizing documents. Portable scanners 170 may also have ports such as USB and/or serial ports to facilitate connection to computing devices 110. In some embodiments, the connection between portable scanners 170 and computing devices 110 may be wireless.

Computing device 110-1 also contains removable storage drive 150. Removable storage drive 150 may include, for example, 3.5 inch floppy drives, CD-ROM drives, DVD ROM drives, CD±RW or DVD±RW drives, and/or any other removable storage drives consistent with embodiments of the present invention. In some embodiments, portions of a software application may reside on removable media and be read and executed by computing device 110 using removable storage drive 150.

Connection 120 couples computing devices 110 and server 130 and may be implemented as a wired or wireless connection using conventional communication protocols and/or data port interfaces. In general, connection 120 can be any communication channel that allows transmission of data between the devices. In one embodiment, for example, the devices may be provided with conventional data ports, such as Ethernet, USB, SCSI, and/or FIREWIRE, ports for transmission of data through the appropriate connection 120. The communication links could be wireless links or wired links or any combination consistent with embodiments of the present invention that allows communication between computing device 110, server 130, and portable scanners 170.

Network 140 could include a Local Area Network (LAN), a Wide Area Network (WAN), or the Internet. In some embodiments, information sent over network 140 may be encrypted to ensure the security of the data being transmitted.

As shown in FIG. 1, system 100 may include multiple portable scanners 170. In one embodiment, portable scanners 170 may be coupled to computing devices 110 and/or server 130. For example, as shown in FIG. 1, exemplary portable scanner 170-2 can be coupled wirelessly to computing device 110-2. In some embodiments, portable scanner 170-2 may be controlled in part by software running on computing device 110-2. A computer software application consistent with embodiments described may be deployed on one or more of the exemplary computers 110, server 130, and/or scanners 170. In general, portable scanners 170 may be controlled by one or more of a combination of software, hardware, and/or firmware. In some embodiments, portable scanners 170 may also be controlled using integrated hardware controllers.

Configuration parameters pertaining to exemplary portable scanners 170 may be user-configurable. For example, portable scanner configuration parameters such as scan resolution, output image format, document size, color encoding may be user-configurable. In general, the nature and type of configuration options will depend on the function of portable scanners 170 and the features available on a specific device. In some embodiments, information transferred to and/or from portable scanners 170 may be transferred to and stored on computing device 110, server 130, and/or removable media devices 180.

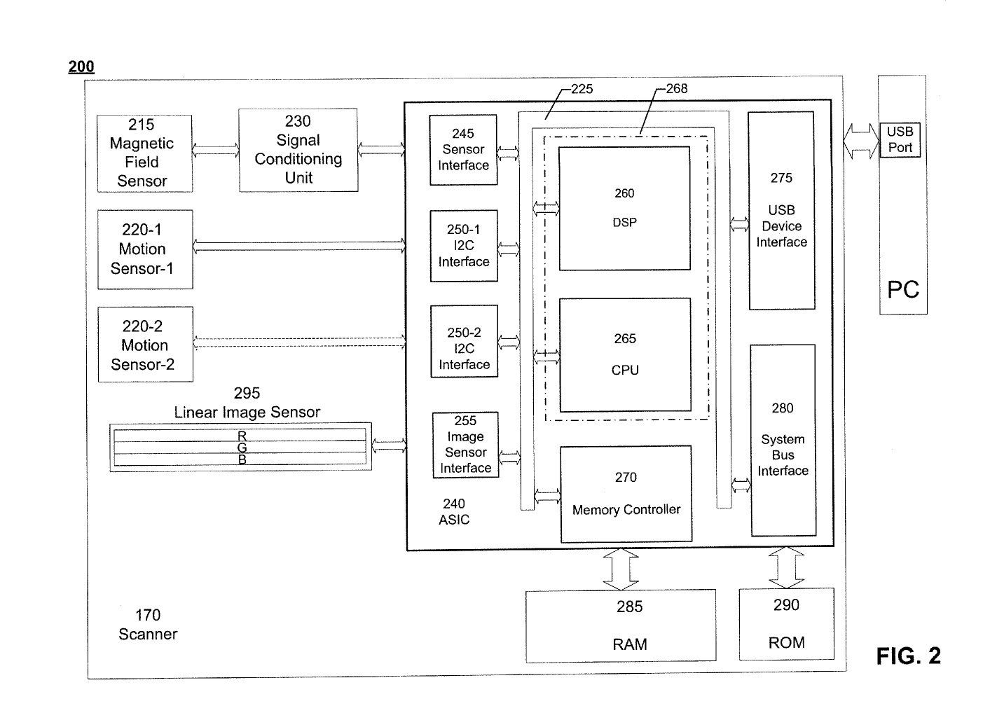

FIG. 2 depicts a block diagram 200 of an exemplary portable scanner 170. It should be noted that the embodiment shown in FIG. 2 is exemplary and for illustrative purposes only and various other implementations would be apparent to one of reasonable skill in the art. Exemplary portable scanner 170 may include an image sensor 210, motion sensors 220, magnetic field sensor 230, linear image sensors 295, and memory, including one or more of Random Access Memory (“RAM”) 285 and/or Read Only Memory (“ROM”) 290. Exemplary portable scanner 170 may also include an Application Specific Integrated Circuit (“ASIC”) 240, which can process signals received from motion sensors 220, linear image sensors 295, and from magnetic field sensor 215 through Signal Conditioning Unit 230. In some embodiments, a Field Programmable Gate Array (“FPGA”), logic, multiple chips and/or other circuitry may be used in lieu of, or in addition to ASIC 240. In some embodiments, exemplary ASIC 240 may consist of multiple chiplets or functional blocks such as sensor interface 245, 12C interfaces 250-1 and 250-2, Processor 268, memory controller 270, Universal Serial Bus (“USB”) Device Interface 275, System Bus 225, and System Bus Interface 280.

In general, Processor 268 may comprise of some combination of appropriately coupled CPUs 265 and/or DSPs 260. For example, Processor 268 may comprise of CPU 265 coupled to Digital Signal Processor (“DSP”) 260, as shown in FIG. 2. Various other combinations of CPUs and/or DSP are also possible. In general, the specific combination of CPUs and/or DSPs may be determined based on various factors such as cost, physical dimensions of portable scanner, heat dissipation, power consumption, performance characteristics desired, etc. and various implementations would be apparent to one of reasonable skill in the art.

In one embodiment, magnetic field sensor 215 may comprise of multiple sensor elements for measuring the x- and y-components of the earth's field in the horizontal plane. For example, magnetic field sensor 215 can include two 2-dimensional field sensors oriented at 90 degrees relative to each other. In some embodiments, magnetic sensor 215 may take advantage of magnetoresistive effects based on characteristics of the earth's magnetic field or other known external magnetic fields to measure the orientation of portable scanner 170 relative to an image on medium being scanned. The magnetoresistive effect refers to the property of a current carrying magnetic material to change its resistance in the presence of an external magnetic field. In general, any magnetic field that is constant over the scan area may be used. If an external magnetic field is used then the external magnetic field may be deliberately generated, or coincidental.

In some embodiments, calibration techniques may be used to account for interference from any magnetic fields that cause distortions in the earth's magnetic field or the external magnetic field being used to determine orientation. For transient interference a low pass filter that suppresses transient variations may be used. In some embodiments, magnetic field sensor may generate a warning signal if interference is detected. In some embodiments, calibration techniques whereby the components of a constant interference field are measured and compensated may be used to mitigate the effects of interference.

Exemplary sensor interface 245 can receive signals from magnetic field sensor 215, which can be conditioned by signal conditioning unit 230 to remove noise and other unwanted interference and to convert the signal to an appropriate digital format capable of being processed by sensor interface 245 in ASIC 240. Signal conditioning unit 230 may also temperature compensate and amplify output voltages of magnetic field sensor 215 to provide input signals within parameters specified for inputs to ASIC 240. In one embodiment, exemplary signal conditioning unit 230 may be capable of direction determination using inputs provided by magnetic field sensor 215. For example, in an embodiment where magnetic field sensor 215 uses two sensor elements, magnetic field sensor 215 may generate two voltages proportional to each sensor element's output. The voltages may be converted to digital values and CPU 265 may calculate the actual angle from these digital values. Exemplary sensory interface 245 can communicate with signal conditioning unit 230 and place any signals received from signal conditioning unit 230 on system bus 225. In some embodiments, magnetic field sensor 215 and signal conditioning unit 230 may be packaged as a single integrated circuit.

Exemplary system bus 225 acts as a conduit for data, signals, and/or commands on ASIC 240 and facilitates communication and data sharing between various functional blocks on ASIC 240, which may operate under the control of CPU 265. For example, CPU 265 may retrieve data from RAM 285 through memory controller 270 by placing an appropriate command and/or address information on system bus 225. The command and address may be used by memory controller 270 to retrieve data from RAM 285, which can be placed on system bus 225 for use by CPU 265. RAM 285 may be any type of memory capable of being accessed by memory controller 270, including SDRAM, RDRAM, or DDR RAM memory modules.

In some embodiments, signals produced by exemplary motion sensors 220-1 and 220-2 may travel over buses such as Inter Integrated Circuit (I²C) buses to I²C interface 250-1 and 250-2, respectively. The use of I²C buses is exemplary only and other types of buses may be used convey sensor data from exemplary motion sensors 220-1 and 220-2 to the appropriate bus interface on ASIC 240. Motion sensors 220-1 and 220-2 can determine the motion of the image sensor relative to the scanned object when the distance between portable scanner 170 and the scanned object does not exceed the sensory threshold of motion sensors 220-1 and 220-2. Exemplary motion sensors 220-1 and 220-2 can provide positional correlation information that can be used to obtain information pertaining to the orientation of portable scanner 170 relative to the image on the medium being scanned. In some embodiments, motion sensors 220-1 and 220-2 may be positioned on either side of linear image sensor 295 to facilitate detection of any rotational movement.

In one embodiment, motion sensors 220-1 and 220-2 and linear image sensor 295 may sample image related data at fixed intervals. In a two motion-sensor device, such as portable scanner 170 with motion sensors 220-1 and 220-2, raw motion sensor data may consists of two 16-bit values, which can represent changes to the X and Y co-ordinates from the immediately prior reading of motion sensors 220-1 and 220-2.

Exemplary linear image sensor 295 can utilize Charge Coupled Device (“CCD”) or Complementary Metal Oxide Semiconductor (“CMOS”) sensor technology. In some embodiments, linear image sensor 295 may consist of three sensor arrays for Red (R), Blue (B), and Green (G) color spaces, respectively. The image signals from linear image sensor 295 is transferred to image sensor interface 255, which can be made up of A/D converters for R, G, and B signals, and other image conditioning means. A/D converters can generate R, G, and B image data from of R, G, and B image signals, respectively, in accordance with amplitude and/or other parameters of each image signal. In some embodiments, position correlation data from motion sensors 220-1 and 220-2 and/or information pertaining to the orientation of portable scanner 170 provided by magnetic field sensor 215 can be stored along with image data for image segments captured by linear image sensor 295.

An image segment represents the image data captured during a single sweep of linear image sensor 295 across a section of the page. A sweep is the period during which the distance between the motion sensors 220 and the medium does not exceed the sensory threshold of motion sensors 220. A sweep commences when portable scanner 170 is placed on the page and ends when distance between the motion sensors 220 and the medium exceeds the sensory threshold of motion sensors 220. Image data captured by portable scanner 170 during this period is referred to as an image segment.

Data from linear image sensor 295, motion sensors 220-1 and 220-2, and magnetic sensor 215 can be used to generate a complete image of the scanned object from image segments by stitching the image segments generated during sweeps together. For example, if more than one pass is used to scan an object, then position correlation data provided by motion sensors 220 can be used to stitch the image segments together to form an image of the scanned object. Image data from linear image sensor 295 can be transferred to RAM 285 in for storage in an appropriate data format. For example, image data may be stored in RAM 185 as 24-bit or 36-bit pixels of RGB data.

Exemplary CPU 265 can receive information captured by sensors in exemplary portable scanner 170 through system bus 225. CPU 265 may also monitor and synchronize the operations of input and output ports on portable scanner 170 with other device elements. For example, CPU 265 can identify the number of endpoints and the various types of USB endpoints using USB Device Interface 275 and coupled computing device 110. CPU 265 may monitor, reset, initialize, and control any user panels and/or display on portable scanner 170. Further, CPU 265 can reset and/or initialize one or more sensors when portable scanner 170 is powered on. In some embodiments, CPU 265 may set sensitivity and/or other parameters for one or more sensors based on user input or directions received from coupled computing device 110 through the appropriate sensor interface. For example, CPU 265 may issue commands over System Bus 225 to image sensor Interface 255 that cause a default profile for linear image sensor 295 to be loaded.

Exemplary CPU 265 can accept commands received from a user or from coupled exemplary computing device 110. For example, CPU 265 may wait for a “start” command from the user to commence scanning operations. Image data and positional correlation information acquired by the various sensors from scanning operations in portable scanner 175 can be sent to or retrieved by CPU 265 through the appropriate sensor interface and System Bus 225. Exemplary CPU 265 can then place image data and associated positional correlation information in RAM 285. In some embodiments, positional correlation information may include positional co-ordinates and information pertaining to scanner orientation relative to the object being scanned. In some embodiments, the user may be asked to provide an indication of the top left corner of the image or page being scanned.

CPU 265 may also detect and monitor events pertaining to motion sensors 220-1 and 220-2. For example, CPU 265 may detect when motion sensors 220-1 and 220-2 start and/or stop providing positional correlation information. For example, motion sensors 220-1 and 220-2 may not be able to provide positional correlation information if the distance between portable scanner 170 and the scanned object exceeds their sensory threshold. For example, motion sensors 220 may cease to provide valid data when they are at a perpendicular distance 10 mm or greater from the medium being scanned. In such situations, exemplary magnetic field sensor 215 and associated signal conditioning unit 230 can provide information about the orientation of portable scanner 170 relative to the scanning medium to CPU 265. In some embodiments, the orientation information generated by magnetic sensor 215 can supplement data provided by the motion sensors 220-1 and 220-2.

In some embodiments, orientation information generated by magnetic sensor 215 can be used when portable scanner 170 is lifted off the medium being scanned such as when the user repositions portable scanner 170 for another sweep across the page. In such a situation, motion sensors 220-1 and 220-2 may be temporarily unable to provide sensory information because the distance of the scanner from the scanning medium may exceed their sensory threshold. CPU 265 may detect when motion sensors 220-1 and 220-2 stop providing positional correlation information.

When portable scanner 170 is returned to the page, data from the magnetic image sensor can be used to provide an “angle correction factor” that is applied to the new set of position data associated with the new sweep of the sensor across the page by the user. CPU 265 may detect when motion sensors 220-1 and 220-2 start providing positional correlation information corresponding to the new sweep. In some embodiments, information from magnetic sensor 215 may be used when information from motion sensors 220-1 and 220-2 is unavailable or unreliable.

In some embodiments, CPU 265 may initialize and control DSP 260. For example, CPU 265 may configure DSP 260 to process image segments. In one instance, DSP 260 may be configured to align the image segments. For example, DSP 260 may rotate the image segments to a common orientation to facilitate a subsequent image segment stitching process. For example, all image segments may be rotated so that they are aligned to a horizontal. In some embodiments, DSP 260 may perform its functions in parallel with image scanning activity performed by portable scanner 170. In some embodiments, DSP 260 may include multiple cores, which may be able to operate in parallel on multiple sets of pixels corresponding to different image segments. In some embodiments, CPU 265 may provide information pertaining to one or more stored image segments to DSP 260. For example, such information can include memory addresses of individual image segments, image segment size, image segment position and orientation information, the type of processing desired, and information on where results may be stored after processing by DSP 260.

In some embodiments, CPU 265 may also configure DSP 260 to examine aligned image segments in memory to detect segment boundaries, identify overlapping regions in the segments, and assemble a complete image of the scanned object. In one embodiment, DSP 260 may run pattern matching algorithm on image segments in parallel with the scanning of other image segments. For example, DSP 260 may be configured to identify overlapping areas of image segments after alignment so that the individual segments can be stitched together to form a complete image of the scanned object. Stitching refers to the process of combining one or more distinct image segments with overlapping regions into a new larger image segment that incorporates information in the original segments without duplication. Overlapping regions can be used as indicators of adjacent segments. In some embodiments, pattern matching algorithms may be used to identify overlapping regions in image segments.

In other embodiments, the entire image may be scanned prior to running pattern matching algorithms. For example, the image segments may be paired and sorted based on the amount of overlap between the segments. In one embodiment, the sorted pairs may be stored in a list. The segment stitching process may commence with the two segments with the most overlap and stitching process may then continue with subsequent elements in the list in order of overlap. In some embodiments, whenever a newly stitched segment is generated by stitching together component segments, the amount of overlap between the newly stitched image segment and any other segments may be updated. For example, the amount of overlap may be updated based on the previously determined overlap between the newly stitched image segment's components and other segments. In some embodiments, the amount of overlap between the newly stitched image segment and any other overlapping segments may be recalculated whenever a newly stitched image segment is generated. The list of image segment pairs may then be updated by adding information pertaining to the newly stitched image segment, deleting information pertaining to its components, and resorting the list of overlapping image segment pairs before the next image segment stitching iteration.

In some embodiments, the amount of overlap may be measured in terms of the number of pixels in the regions of image segments that have been determined to overlap by the pattern matching algorithm. In situations where the pattern matching algorithm may yield incorrect or inaccurate results, a user override may be provided to allow user input to the image segment stitching process. For example, the pattern matching algorithm may be disabled and the user may run the scanner over the image while remaining within the sensory threshold of motion sensors 220-1 and 220-2. In images with large contiguous amounts of white space or non-varying color, the user may be allowed to indicate these regions and run scanner over the rest of the image.

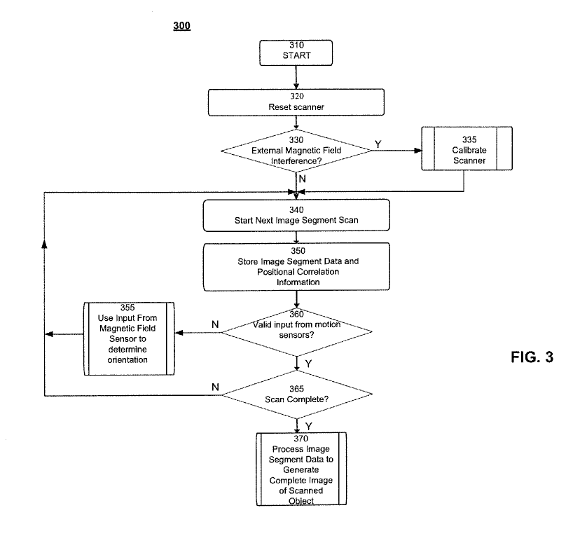

FIG. 3 depicts a flowchart 300 showing steps in an exemplary processing of a scanned image. Portions of an application implementing steps in flowchart 300 may be executed on one or more of portable scanner 170, coupled computing device 110, and/or coupled server 130. The exemplary process shown can start in step 310. In step 320, portable scanner 170 may be powered on or reset. In some embodiments, a reset may cause sensor and functional block initialization routines, which may be stored in ROM 280, to be run. In some embodiments, System Bus 225 may be reset and RAM 285 may be cleared. In step 330, if portable scanner 170 indicates, or a user suspects, that magnetic field interference is present then the scanner may be calibrated in step 335 to mitigate or compensate for the effects of any interference.

In step 340, the user may begin scanning a new image segment. In some embodiments, the scan process may begin at a certain point on the image being scanned, for example, the top left. In step 350, positional correlation information, orientation information, and image data obtained by portable scanner 170 may be stored in RAM 285. In step 360, motion sensors 220-1 and 220-2 may be polled to check if their data output is valid.

For example, the data output by motion sensors 220-1 and 220-2 may be invalid or inaccurate, if the user lifts the portable scanner off the page and the sensory threshold of the motion sensors is exceeded. In some embodiments, motion sensors 220-1 and 220-2 may provide a “data valid” or similar output to indicate that their output is valid. In step 355, if portable scanner 170 has been lifted off the page and data output by motion sensors 220-1 and 220-2 is no longer valid, then data output by magnetic field sensor 215 may be used to determine the orientation of portable scanner 170 for the next image segment scan. In some embodiments, the data output by magnetic field sensor 215 may be used to provide an “angle correction factor” that may be applied to and/or associated with the next set of image segment data that may be scanned in step 340. In some embodiments, the angle correction factor may be used to rotate image segments to a common orientation to facilitate a subsequent image segment stitching process. For example, all image segments may be rotated so that they are horizontally aligned. In some embodiments, DSP 260 may rotate image segments while portable scanner 170 is scanning other image segments.

If it is determined that the entire object has been scanned in step 365, then image segment data may be processed in step 370 to assemble the object from the various segments. In some embodiments, the processing of image segments may be performed in parallel with the image scanning process. For example, steps 340 through 365 for an object may be performed in parallel with step 370 for a different object. In some embodiments, a pattern matching algorithm may be used to assemble the image segments in memory. For example, overlapping areas of image segments may be identified after the image segments have been aligned to facilitate the image segment stitching process. The presence of overlapping regions can be used as an indication that the segments are adjacent.

In some embodiments, processor 268 may determine a best fit for the image in a frame after the image stitching process. In other embodiments, a pre-determined image segment may be used as an anchor during the image segment stitching process. For example, the scanning process may be designed so that the user provides an indication when a scan begins at the top left corner of an image or page being scanned. The top left image segment may then be used as an anchor to tie the other scanned image segments together.

Further, methods consistent with embodiments of the invention may conveniently be implemented using program modules, hardware modules, or a combination of program and hardware modules. Such modules, when executed, may perform the steps and features disclosed herein, including those disclosed with reference to the exemplary flow charts shown in the figures. The operations, stages, and procedures described above and illustrated in the accompanying drawings are sufficiently disclosed to permit one of ordinary skill in the art to practice the invention.

The above-noted features and aspects of the present invention may be implemented in various environments. Such environments and related applications may be specially constructed for performing the various processes and operations of the invention, or they may include a general-purpose computer or computing platform selectively activated or reconfigured by program code to provide the functionality. The processes disclosed herein are not inherently related to any particular computer or other apparatus, and aspects of these processes may be implemented by any suitable combination of hardware, software, and/or firmware. For example, various general-purpose machines may be used with programs written in accordance with teachings of the invention, or it may be more convenient to construct a specialized apparatus or system to perform the required methods and techniques.

Other embodiments of the invention will be apparent to those skilled in the art from consideration of the specification and practice of the embodiments of the invention disclosed herein. It is intended that the specification and examples be considered as exemplary only, with a true scope and spirit of the invention being indicated by the following claims. As such, the invention is limited only by the following claims.

1. A portable scanner comprising:
at least one processor capable of processing image data;
at least one image sensor coupled to the processor, wherein the image sensor is capable of scanning images on a medium and communicating scanned image data to the processor;
memory coupled to the processor capable of storing image data;
at least one motion sensor coupled to the processor, wherein the motion sensor provides positional correlation information for the scanned image data; and
at least one magnetic field sensor coupled to the processor, wherein the magnetic field sensor provides information pertaining to the orientation of the portable scanner to the processor.

2. The apparatus of claim 2, wherein the image data provided by the image sensor to the processor is composed of image segment data, wherein an image segment comprises data captured during a single sweep of the image sensor over the medium.

3. The apparatus of claim 1, wherein the processor comprises of a CPU coupled to a DSP, wherein the DSP performs image processing operations on the image data based on instructions from the CPU.

4. The apparatus according to claim 3, wherein the image processing operations include rotating image segments to a common orientation.

5. The apparatus according to claim 3, wherein the DSP performs image processing operations on the image data in parallel with image scanning operations.

6. The apparatus of claim 1, wherein motion sensor includes a signal to indicate the validity of positional correlation information provided by the sensor.

7. The apparatus of claim 6, wherein the CPU uses orientation information provided by the magnetic field sensor, when the positional correlation information provided by the motion sensor is not valid.

8. The apparatus of claim 7, wherein the magnetic field sensor uses variations in the earth's magnetic field strength relative to the angular position of the magnetic field sensor to determine the orientation of the portable scanner.

9. The apparatus of claim 7, wherein the magnetic field sensor uses variations in an external magnetic field strength relative to the angular position of the magnetic field sensor to determine the orientation of the portable scanner.

10. The apparatus of claim 8, wherein the magnetic field sensor can be calibrated to account for interference from external magnetic fields.

11. The apparatus of claim 1, wherein the magnetic field sensor is further coupled to a low pass filter to eliminate transient interference from other electromagnetic fields.

12. The apparatus of claim 1, wherein the portable scanner includes a wireless interface to transfer processed image data.

13. The apparatus of claim 3, wherein the CPU and DSP are packaged in an ASIC, wherein the ASIC may further comprise one or more of memory, internal buses, at least one interface for communication with devices coupled to the portable scanner and at least one external memory interface.

14. The apparatus of claim 1, wherein the portable scanner is a handheld scanner.

15. A method for maintaining positional correlation information obtained from motion sensors in a portable scanner relative to image data on a medium, the method comprising:
associating the positional correlation information with scanned image data, wherein the positional correlation information is generated during a sweep;
obtaining information pertaining to the orientation of the portable scanner from magnetic field sensors in the portable scanner, during a period when the distance between the motion sensors and the medium exceeds the sensory threshold of the motion sensors; and
using the orientation information obtained from magnetic field sensors to the correct positional correlation information obtained from motion sensors, wherein:
the orientation information used for correction is obtained within a time interval of the start of an immediately subsequent sweep; and
the orientation information is used to correct the positional correlation information for the immediately subsequent sweep.

16. The method of claim 15, wherein the method is executed on the portable scanner.

17. The method of claim 16, wherein the portable scanner is a handheld scanner.

18. A system comprising
at least one CPU capable of processing image data;
at least one image sensor coupled to the CPU, wherein the image sensor is capable of sensing images on a medium and communicating the image data sensed from the medium to the CPU;
memory coupled to the CPU capable of storing the image data;
at least one motion sensor coupled to the CPU, wherein the motion sensor provides positional correlation information for the image data sensed by the image sensor;
at least one magnetic field sensor coupled to the CPU, wherein the magnetic field sensor provides information pertaining to the orientation of the portable scanner to the CPU; and
at least one DSP coupled to the CPU, wherein the DSP is capable of performing image processing operations on the image data based on instructions from the CPU.

19. The system according to claim 19, wherein the image processing operations include rotating image segments to a common orientation, wherein an image segment comprises data captured during a single sweep of the image sensor over the medium.

20. The system according to claim 19, wherein the DSP performs image processing operations on the image data in parallel with image scanning operations.
